(19) United States
(12) Patent Application Publication
(10) Pub. No.: US 2005/0044109 A1
(43) Pub. Date: Feb. 24, 2005

(54) Mail system, mail processing method, computer-readable recording medium that records mail processing program, electronic mail storage device, electronic mail storage method and computer-readable recording medium that records electronic mail storage program

(75) Inventor: Katsushi Nanba, Inagi (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/792,768

(22) Filed: Mar. 5, 2004

(30) Foreign Application Priority Data
Aug. 21, 2003 (JP) 2003-208294

(51) Int. Cl. G06F 7/00

(52) U.S. Cl. 707/104.1

(57) ABSTRACT

Before a mail transmitted from a client is sent to a SMTP server, a virtual SMTP server receives the mail, then judges whether or not a delete code, an update code, etc are attached to the mail received by the virtual SMTP server, and executes a process on the mail stored in the virtual server on the basis of this judgment.

### BACKGROUND OF THE INVENTION

1. Field of the Invention

The invention relates to a mail system, a mail processing method, a computer-readable recording medium that records a mail processing program, an electronic mail storage device, an electronic mail storage method and a computer-readable recording medium that records an electronic mail storage program for executing a process on a mail transmitted by a mailer available on the market and an existing mailer.

2. Description of the Related Art

There has hitherto been developed a system for suspending a mail transmission after a user has given a instruction of transmitting a mail.

For example, in the prior art, a personal computer on the side of sending the mail is provided with software-based virtual SMTP server, wherein the mail transmission is suspended on the software-based virtual SMTP server before forwarding the transmitted mail to a real SMTP.

A limit time is set in the suspension of this mail transmission, and cancellation can be manually effected after transmitting the mail if within a range of the thus-set limit time. A chance of modifying a wrong mail can be thereby given. [Patent Document 1]

Japanese Patent Application Laid-Open Publication No.2001-350694

[Patent document 2]

Japanese Patent Application Laid-Open Publication No.7-131480

In the prior art, however, the virtual SMTP server suspends the mail transmission, and nevertheless, in the case of discovering a mistake in contents of the transmitted mail, the mail transmission must be manually canceled. Besides, a mail after being corrected must be resent as a new mail.

Further, the specifications of the prior art support only a specified mailer, wherein the mailer usually used by a user can not be utilized unless this specified mailer is employed.

### SUMMARY OF THE INVENTION

An object of the invention lies in providing an a mail system, a mail processing method, a computer-readable recording medium that records a mail processing program, an electronic mail storage device, an electronic mail storage method and a computer-readable recording medium that records an electronic mail storage program enabling processes such as deleting and updating a transmitted mail irrespective of a type of a mailer utilized by a user, and capable of improving usability thereof.

A mail system according to the invention is a virtual server in a mail system which comprises a client for transmitting a mail and a server for receiving the mail, said mail system comprising: a receiving unit receiving a first mail transmitted from said client and receiving a second mail transmitted from said client after the first mail; a storage unit storing the first mail received; a judging unit judging whether a process code for processing the first mail and specifying information for specifying the first mail are attached to the second mail or not; a processing unit executing, in a case where the process code and the specifying information are attached to the second mail, a process for the first mail stored on said storage unit and specified by the specifying information in accordance with the process code; and a transmitting unit transmitting, after a fixed period of time has elapsed since the receipt of the first mail, to said server the first mail stored on said storage unit or the second mail of which the process code and the specifying information have been deleted.

Further, in the mail system according to the invention, wherein the process code is attached to a body of the second mail.

Further, in the mail system according to the invention, the process code is attached to a subject of the second mail.

Further, in the mail system according to the invention, the specifying information is attached to a body of the second mail.

Further, in the mail system according to the invention, the specifying information is attached to a subject of the second mail.

Further, in the mail system according to the invention, the process code attached to the second mail is an update code indicating a process of updating a body of the first mail, contents of an updated body of the first mail is attached to a body of the second mail, and said processing unit deletes the specifying information and the update code attached to the second mail, deletes the first mail specified by the specifying information and stores in said storage unit the second mail of which the specifying information and the update code have been deleted.

Further, in the mail system according to the invention, wherein the process code attached to the second mail is an update code indicating a process of deleting the first mail, and said processing unit deletes the first mail specified by the specifying information from said storage unit.

Further, in the mail system according to the invention, the process code attached to the second mail is an update code indicating a process of updating a destination of the first mail, the second mail is sent to an updated destination, and said processing unit deletes the specifying information and the update code attached to the second mail, deletes the first mail specified by the specifying information and stores in said storage unit the second mail of which the specifying information and the update code have been deleted.

Further, in the mail system according to the invention, the process code attached to the second mail is a change code indicating a process of changing a file attached to the first mail, a changed file attached to the first mail is attached to the second mail, and said processing unit deletes the specifying information and the change code attached to the second mail, deletes the first mail specified by the specifying information and stores in said storage unit the second mail to which the changed file has been attached and of which the specifying information and the change code have been deleted.

Further, a mail processing method according to the invention is a mail processing method for a virtual server in a mail system which comprises a client for transmitting a mail and a server for receiving the mail transmitted from said virtual server, said mail processing method comprising: receiving a first mail transmitted from said client; receiving a second mail transmitted from said client after the first mail; storing in a storage unit the first mail received; judging whether a process code for processing the first mail and specifying information for specifying the first mail are attached to the second mail or not; executing, in a case where the process code and the specifying information are attached to the second mail, a process for the first mail stored on said storage unit and specified by the specifying information in accordance with the process code; and transmitting, after a fixed period of time has elapsed since the receipt of the first mail, to said server the first mail stored on said storage unit or the second mail of which the process code and the specifying information have been deleted.

Further, in the mail processing method according to the invention, the process code is attached to a body of the second mail.

Further, in the mail processing method according to the invention, the process code is attached to a subject of the second mail.

Further, in the mail processing method according to the invention, the specifying information is attached to a body of the second mail.

Further, in the mail processing method according to the invention, the specifying information is attached to a subject of the second mail.

Further, in the mail processing method according to the invention, the process code attached to the second mail is an update code indicating a process of updating a body of the first mail, contents of an updated body of the first mail is attached to a body of the second mail, and said mail processing method further comprises: deleting the specifying information and the update code attached to the second mail; deleting the first mail specified by the specifying information; and storing in said storage unit the second mail of which the specifying information and the update code have been deleted.

Further, in the mail processing method according to the invention, the process code attached to the second mail is an update code indicating a process of deleting the first mail, and said mail processing method further comprises: deleting the first mail specified by the specifying information from said storage unit.

Further, in the mail processing method according to the invention, the process code attached to the second mail is an update code indicating a process of updating a destination of the first mail, the second mail is sent to an updated destination, and said mail processing method further comprises: deleting the specifying information and the update code attached to the second mail; deleting the first mail specified by the specifying information; and storing in said storage unit the second mail of which the specifying information and the update code have been deleted.

Further, in the mail processing method according to the invention, the process code attached to the second mail is a change code indicating a process of changing a file attached to the first mail and a changed file attached to the first mail is attached to the second mail, and said mail processing method further comprises: deleting the specifying information and the change code attached to the second mail; deleting the first mail specified by the specifying information; and storing in said storage unit the second mail to which the changed file has been attached and of which the specifying information and the change code have been deleted.

Further, a computer-readable recording medium that records a mail processing program according to the invention is a mail processing program executed by a computer that functions as a virtual server in a mail system which comprises a client for transmitting a mail and a server for receiving the mail transmitted from said virtual server, said mail processing program comprising: receiving a first mail transmitted from said client; receiving a second mail transmitted from said client after the first mail; storing in a storage unit the first mail received; judging whether a process code for processing the first mail and specifying information for specifying the first mail are attached to the second mail or not; executing, in a case where the process code and the specifying information are attached to the second mail, a process for the first mail stored on said storage unit and specified by the specifying information in accordance with the process code; and transmitting, after a fixed period of time has elapsed since the receipt of the first mail, to said server the first mail stored on said storage unit or the second mail of which the process code and the specifying information have been deleted.

Further, in the computer-readable recording medium that records a mail processing program according to the invention, the process code is attached to a body of the second mail.

Further, in the computer-readable recording medium that records a mail processing program according to the invention, the process code is attached to a subject of the second mail.

Further, in the computer-readable recording medium that records a mail processing program according to the invention, the specifying information is attached to a body of the second mail.

Further, in the computer-readable recording medium that records a mail processing program according to the invention, the specifying information is attached to a subject of the second mail.

Further, in the computer-readable recording medium that records a mail processing program according to the invention, wherein the process code attached to the second mail is an update code indicating a process of updating a body of the first mail, contents of the updated body of the first mail is attached to the body of the second mail, and said executing step comprises: deleting the specifying information and the update code attached to the second mail, deleting the first mail specified by the specifying information, and storing in said storage unit the second mail of which the specifying information and the update code have been deleted.

Further, in the computer-readable recording medium that records a mail processing program according to the invention, the process code attached to the second mail is an update code indicating a process of deleting the first mail, and said executing step comprises deleting the first mail specified by the specifying information from said storage unit.

Further, in the computer-readable recording medium that records a mail processing program according to the invention, the process code attached to the second mail is an update code indicating a process of updating a destination of the first mail, the second mail is sent to an updated destination, and said executing step comprises deleting the specifying information and the update code attached to the second mail, deleting the first mail specified by the specifying information and storing in said storage unit the second mail of which the specifying information and the update code have been deleted.

Further, in the computer-readable recording medium that records a mail processing program according to the invention, the process code attached to the second mail is a change code indicating a process of changing a file attached to the first mail, a changed file attached to the first mail is attached to the second mail, and said executing step comprises deleting the specifying information and the update code attached to the second mail, deleting the first mail specified by the specifying information and storing in said storage unit the second mail to which the changed file has been attached and of which the specifying information and the update code have been deleted.

Further, an electronic mail storage device according to the invention is an electronic mail storage device, comprising: a storage unit storing the electronic mail; a receiving unit receiving an electronic mail to be temporarily stored in said storage unit; a search unit searching the electronic mail received by said receiving unit for a piece of specifying information for specifying other electronic mail stored on said storage unit and a piece of process information for processing an electronic mail specified by the specifying information; and a processing unit executing, in a case the electronic mail includes the piece of process information and the piece of specifying information, a process for the specified electronic mail in accordance with the piece of process information.

Further, in the electronic mail storage device according to the invention, the piece of process information is a piece of update information indicating a process of updating a body of the specified electronic mail, contents of an updated body of the specified electronic mail is attached to a body of the electronic mail, and said processing unit deletes the piece of specifying information and the piece of update information from the electronic mail, deletes the specified electronic mail from said storage unit, and stores the electronic mail on said storage unit.

Further, in the electronic mail storage device according to the invention, the piece of process information is a piece of update information indicating a process of deleting the specified electronic mail, and said processing unit deletes the specified electronic mail from said storage unit.

Further, an electronic mail storage method according to the invention is an electronic mail storage method of temporarily storing in a storage device an electronic mail to be transmitted, comprising: receiving an electronic mail to be temporarily stored in a storage device; searching the received electronic mail for a piece of specifying information for specifying other electronic mail stored on said storage device and a piece of process information for processing an electronic mail specified by the piece of specifying information; and executing, in a case the received electronic mail includes the piece of process information and the specifying information, a process for the specified electronic mail in accordance with the piece of process information.

Further, a computer-readable recording medium that records an electronic mail storage program according to the invention is an electronic mail storage program for temporarily storing in a storage device an electronic mail to be transmitted, said program making a computer execute: receiving operation receiving an electronic mail to be temporarily stored in a storage device; searching operation searching the received electronic mail for a piece of specifying information for specifying other electronic mail stored on said storage device and a piece of process information for processing an electronic mail specified by the specifying information; and processing operation processing, in a case the received electronic mail includes the piece of process information and the piece of specifying information, for the piece of specified electronic mail in accordance with the piece of process information.

Owing to the invention, the virtual server surrogates all of canceling the transmission of a wrong mail, updating it into a modified mail and forwarding the mail while taking over functions of all types of mailers and mail transmitting/receiving functions, thereby improving usability.

Namely, it is possible to provide a mechanism capable of modifying or updating by use of the same mail as the mail after being transmitted without any operation of canceling or deleting the post-transmission mail.

Note that the specifying information connotes, e.g., Message-ID.

### BRIEF DESCRIPTION OF THE DRAWINGS

FIG. 1 is a conceptual diagram of a mail system to which one embodiment of an electronic mail storage method according to the invention is applied;

FIG. 2 is a block diagram of functions possessed by a virtual SMTP server 102 shown in FIG. 1;

FIG. 3 is a conceptual diagram showing how a mail is hooked (intercepted) in the virtual SMTP server 102 shown in FIG. 1;

FIG. 4 is a flowchart of an operation of one embodiment of the electronic mail storage method according to the invention;

FIG. 5 is a flowchart of the operation of one embodiment of the electronic mail storage method according to the invention;

FIG. 6 is a flowchart of the operation of one embodiment of the electronic mail storage method according to the invention;

FIG. 7 is a flowchart of the operation of one embodiment of the electronic mail storage method according to the invention;

FIG. 8 is conceptual diagram of an operation of a Message-ID matching process in S711 shown in FIG. 7;

FIG. 9 is a conceptual diagram of a mechanism for updating a wrong mail into a corrected mail in one embodiment of the electronic mail storage method according to the invention;

FIG. 10 is a conceptual diagram of data in DB to which the virtual SMTP server refers when updating the wrong mail into the corrected mail in one embodiment of the electronic mail storage method according to the invention.

### DESCRIPTION OF THE PREFERRED EMBODIMENTS

Preferred embodiments of the invention will hereinafter be explained in detail by way of exemplifications with reference to the drawings. The scope of the invention is not, however, intended to be limited only to dimensions, materials, shapes and relative dispositions of components described in the embodiments unless specific descriptions are given.

Further, throughout the following drawings, the same members as those shown in the drawings given above are marked with the same numerals.

<Conceptual Diagram of Electronic Mail Storage Method>

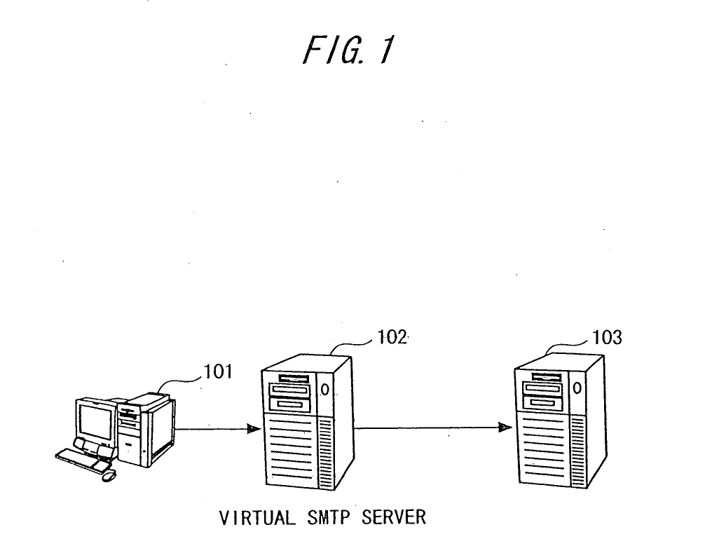

One embodiment of an electronic mail storage method according to the invention will hereinafter be described with reference to the drawings. FIG. 1 shows a conceptual diagram of a mail system to which one embodiment of the electronic mail storage method according to the invention, is applied.

As illustrated in FIG. 1, the mail system to which one embodiment of the electronic mail storage method according to the invention is applied, includes a client (personal computer) 101 on a mail transmitting side, and an SMTP (Simple Mail Transfer Protocol) server 103 for transferring a received mail to a destination. Note that this SMTP server 103 may be termed a real SMTP server in a sense of making a comparison with a virtual SMTP server 102.

The mail system to which one embodiment of the electronic mail storage method according to the invention is applied, further includes the virtual SMTP server 102 actualized by software.

This virtual SMTP server 102 may be installed either the client 101 or the SMTP server 103. Moreover, the virtual SMTP server 102 may be installed into, though not illustrated in FIG. 1, a mail server connected via a network to the client 101. In the following discussion, a case of installing the virtual SMTP server 102 into the client 101, will be explained. Note that if the virtual SMTP server 102 is installed into the SMTP server 103, a mail processing efficiency rises because of the SMTP server 103 having a high throughput.

Moreover, the virtual SMTP server 102 is the software independent of a mailer provided in, e.g., the client 101.

Namely, the virtual SMTP server 102 receives, as a temporary SMTP server, the mail sent from the mailer provided in the client 101.

Therefore, the mailer of the client 101 sets a server name of the SMTP server in the virtual SMTP server 102.

Therefore, the virtual SMTP server 102 in the embodiment is independent of the mailer provided in the client 101 and is usable irrespective of a type of the mailer installed into the client 101.

As shown in FIG. 1, the mail system to which the electronic mail storage method in the embodiment is applied, is such that the virtual SMTP server 102 constructed softwarewise is installed into an interior of the client 101, and the virtual SMTP server 102 hooks (intercepts) the mail forwarded to the existing SMTP server 103, thus suspending the transmission to the SMTP server 103. This hook (interception) will be explained later on.

Hereat, the mail suspended by the virtual SMTP server 102 is stored for a fixed period of time in a database (which hereinafter be abbreviated to DB) of the virtual SMTP server 102. This period of time can be, however, set by a setting person, etc. of the virtual SMTP server 102. Further, the database of the virtual SMTP server 102 is stored with various categories of information about the suspended mail.

Moreover, the virtual SMTP server 102 executes deleting and updating of the mail to be corrected, and also executes a process of judging whether the suspended mail has been sent to a destination side or not.

<Functions of Virtual SMTP Server>

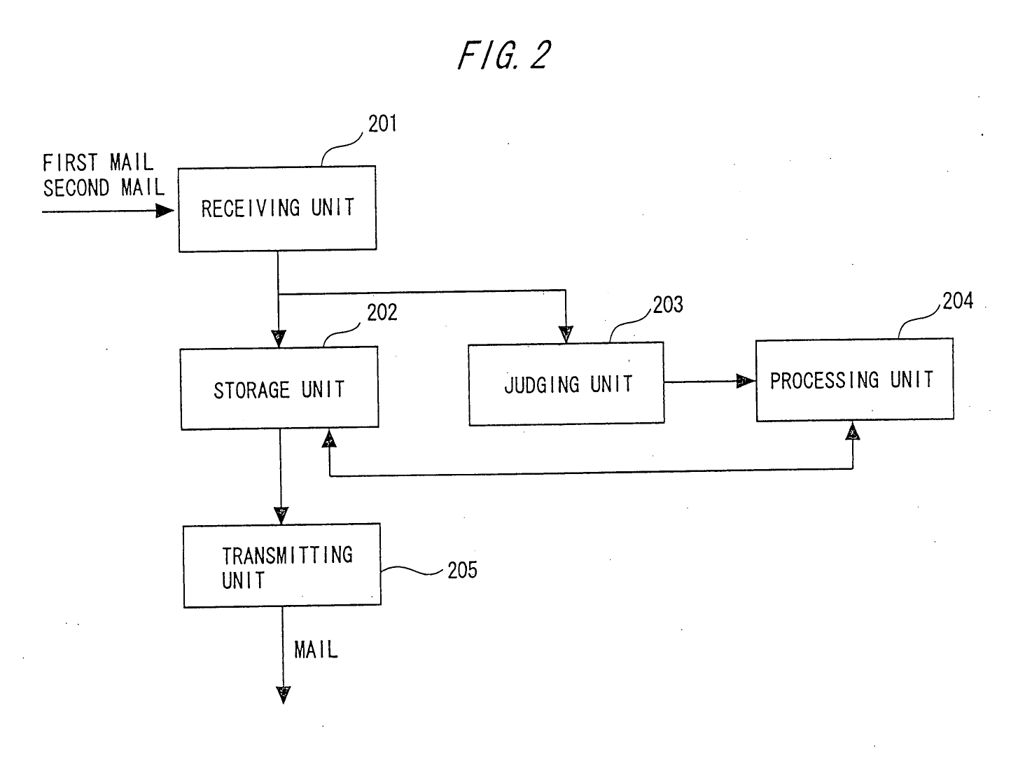

Next, functions possessed by the virtual SMTP server 102 shown in FIG. 1 will be explained referring to FIG. 2. FIG. 2 is a block diagram of the functions possessed by the virtual SMTP server 102 shown in FIG. 1.

As shown in FIG. 2, the virtual SMTP server 102 includes a receiving unit 201 for executing a process of receiving a first mail and a second mail, and a storage unit 202 for executing a process of storing data, etc. of the mails received by the receiving unit 201. Herein, the first mail connotes a mail attached with none of processing codes that will hereinafter be explained. Further, the second mail connotes a mail received by the virtual SMTP server with a time delay behind the first mail in order to effect the processing on the first mail, and serving to execute the processing on the first mail.

Further, the storage unit 202 cooperates with, for example, a hard disk, etc. to structure the database (DB) of the virtual SMTP server.

Moreover, as shown in FIG. 2, the virtual SMTP server 102 includes a judging unit 203 for judging whether or not the processing code is attached to the second mail received by the receiving unit 201.

Still further, as illustrated in FIG. 2, the virtual SMTP server 102 includes a processing unit 204 for executing processes such as deleting and updating with respect to the mails stored on the storage unit 202 on the basis of the judgment by the judging unit 203.

Further, as shown in FIG. 2, the virtual SMTP server 102 includes a transmitting unit 205 for transmitting the mail stored on the storage unit 202 after an elapse of a fixed period of time since the mail has been stored on the storage unit 202.

The mail transmitted by the transmitting unit 205 is the first mail that is stored on the storage unit 202 but does not yet undergo the updating process, or the second mail after undergoing a predetermined process, which has replaced the first mail.

CPU of the devices (the server and the client) installed with the software of the virtual SMTP server cooperate with the software of the virtual SMTP server, thereby actualizing the respective functions of the virtual SMTP server shown in FIG. 2.

<Concerning Hook (Interception)>

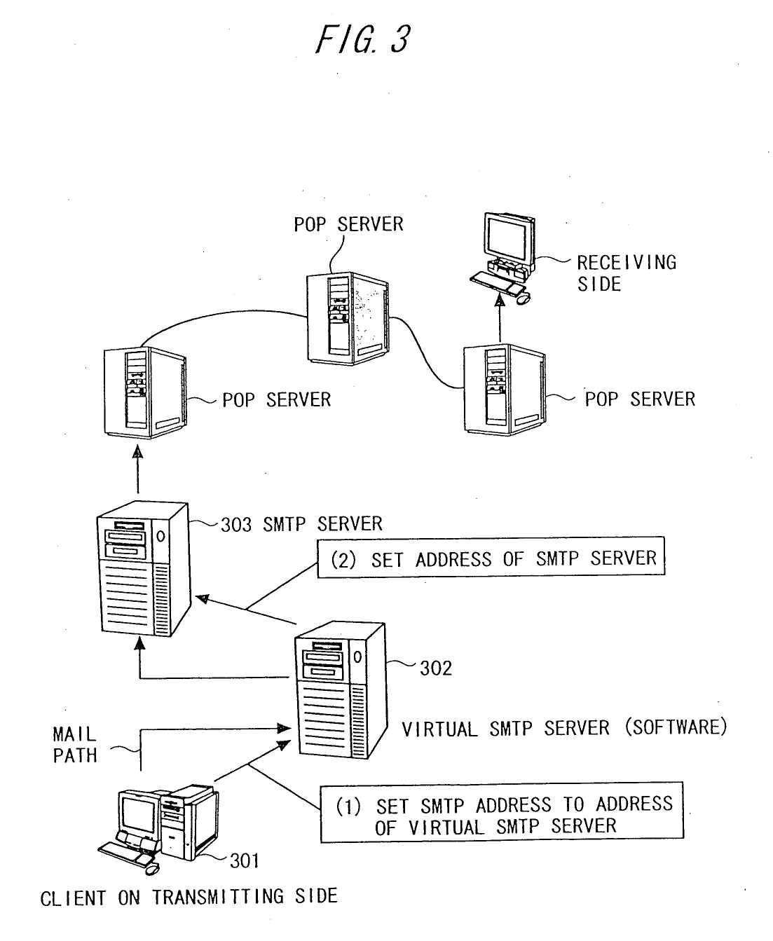

Next, the mail hooking (intercepting) conducted in the virtual SMTP server 102 shown in FIG. 1 will be explained referring to FIG. 3. FIG. 3 is a conceptual diagram showing how the mail is hooked (intercepted) by the virtual SMTP server 102 shown in FIG. 1.

The hooking (intercepting) is the same in terms of a concept as by a normal setting method in the mailer.

As shown by (1) in FIG. 3, after installing the software of a virtual SMTP server 302 into a client 301 on the transmitting side, the transmitting-side client 301 sets the virtual SMTP server 302 as a destination SMTP address of the mail.

Further, as shown by (2) in FIG. 1, the virtual SMTP server 302 designates a real SMTP server 303 as a destination SMTP address of the mail.

With this contrivance, in the transmitting-side client 301, the transmission of the mail to the real SMTP server 303 is cut off, and instead the virtual SMTP server 302 surrogates the actual mail transmission.

<Operation of Electronic Mail Storage Method>

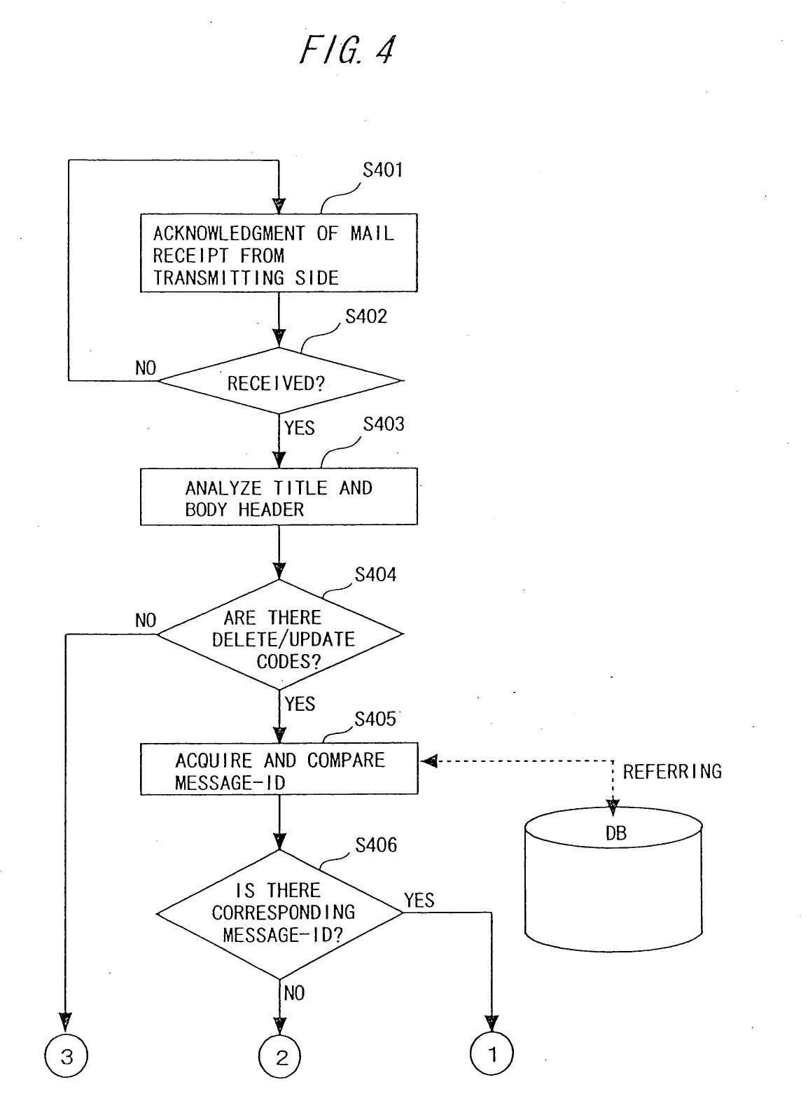

Next, an operation of the electronic mail storage method according to the invention illustrated in FIG. 1, will hereinafter be described with reference to FIGS. 4, 5, 6 and 7. FIGS. 4 through 7 show flowcharts of the operation in one embodiment of the electronic mail storage method according to the invention. Incidentally, an assumption in the following discussion is that any one of a delete process of deleting the mail and an update process of updating contents of the mail is to be executed as a process for the mail. In the electronic mail storage method of the invention, however, the process for the mail is not limited to any one of the delete process of deleting the mail and the update process of updating the contents of the mail, and other processes may also be available.

(Process on Sender Side)

FIG. 4 is the flowchart of the process of updating or deleting the mail. For deleting the already-transmitted mail or updating it into a mail after being corrected, at first the following operation must be done on the transmitting side.

1) Check Message-ID of the transmitted (corrected) mail.

Herein, the check of the Message-ID of the mail will be explained. When the client sends the mail, the virtual SMTP server having received the mail notifies the client of the mail in a way that adds Message-ID to a mail header of this mail.

Then, the client having received the notification stores its own storage unit (which is also called an out-box and will hereinafter be simply referred to as the out-box) with the mail header sent back from the virtual SMTP server as a mail header of the mail transmitted.

Accordingly, at a point of time when the client stores the transmitted mail in the out-box, a process of associating the mail with Message-ID has already been completed.

The association of the transmitted mail with Message-ID in the client involves the use of a method recommended in the RFC (Request For Comment) documents. For example, the mail transmission by the client, the receipt of Message-ID of the client and the addition of Message-ID to the transmitted mail, may be executed as one closed transaction.

To attain this, there is required a mailer of such a type that the generation of Message-ID is assigned to the SMTP server, and a large number UNIX mailers conform in their standards with this type of mailer.

Then, in the case of effecting the process on the transmitted mails, the mail as a processing object exists in the out-box. Therefore, Message-Id is detected by checking the mail header, and its contents can be confirmed.

Note that if a format of Message-ID conforms to the standards, the client mailer independently adds Message-ID to the mail before the mail is transmitted, and this is permitted by the standards. Accordingly, in this case, for the process of the already-transmitted mail which will be explained later on, Message-ID created by the client is attached to the mail for the processing.

Conversely, in a case where the client does not create Message-ID, the standards prescribe that the SMTP server is to create Message-ID in its own way.

The case where the client creates Message-ID is a system adopted by the majority of general mailers.

The virtual SMTP server is, however, UMA (User Message Agent) software pursuant to the standards and therefore supports such a case, and, in this case, Message-ID attached by the client is Message-ID of the same mail stored on the virtual SMTP server. In this case also, the method of notifying the client of the mail header is the same as the normal method.

Herein, the UMA (User Message Agent) software (or simply called UMA) is software utilized for the user to read and write the message. A system, which does not have its own MTA (Message Transfer Agent), includes functions as a POP (Post Office Protocol) client, an IMAP (Internet Message Access Protocol) client and a SMTP client. Details thereof are written in RFC documents.

Further, MTA (Message Transfer Agent) is software for delivering the message between hosts. Details thereof are written in RFC documents.

2) A delete code or an update (renew) code (which will hereinafter be also generically termed processing codes) is added to a subject field (e.g., the head of a mail subject) of a subject of the mail to be transmitted (corrected) or to a mail body (for instance, a body header as the head of the mail body). The processing code for use is the code defined by the virtual SMTP server. The following is one example of the processing codes, and the processing codes used for the mail transmitting method of the invention are not limited to the following examples.
Example) Delete code: DELETE-ML
Update code: RENEW-ML

3) Message-ID is attached to the subject field (the head of the mail subject) of the mail, or to the mail body (e.g., the body header (the head of the mail body).
(Example) DELETE-ML
0993302442232ssrx3000@xxxxx.co.jp
. . . body . . .

4) Together with the above, the mail after being corrected is sent (by a “send button”, etc.) to the virtual SMTP server.

Next, processes on the side of the virtual SMTP server having received the mail will be explained with reference to a flowchart in FIG. 4. The flowchart in FIG. 4 illustrates an outline of processes by the UMA installed into the software of the virtual SMTP server of the invention. Herein, the UMA is a simple name of software in terms of the standards in the mail system. The server is nothing but a server unless it has the UMA software, and the server functioning as the mail server requires the UMA software.

(Processes on Virtual SMTP Server Side)

The virtual SMTP server having received the mail from the client on the transmitting side, at first confirms the subject and the body header of the received mail, and checks whether or not the processing code such as the delete code or the update code is attached thereto (S401-S404).

Herein, the body header is the head of “body” of the mail and indicates an uppermost position of the body. As a matter of course, the invention is not limited to the case where the processing code is attached to the body header.

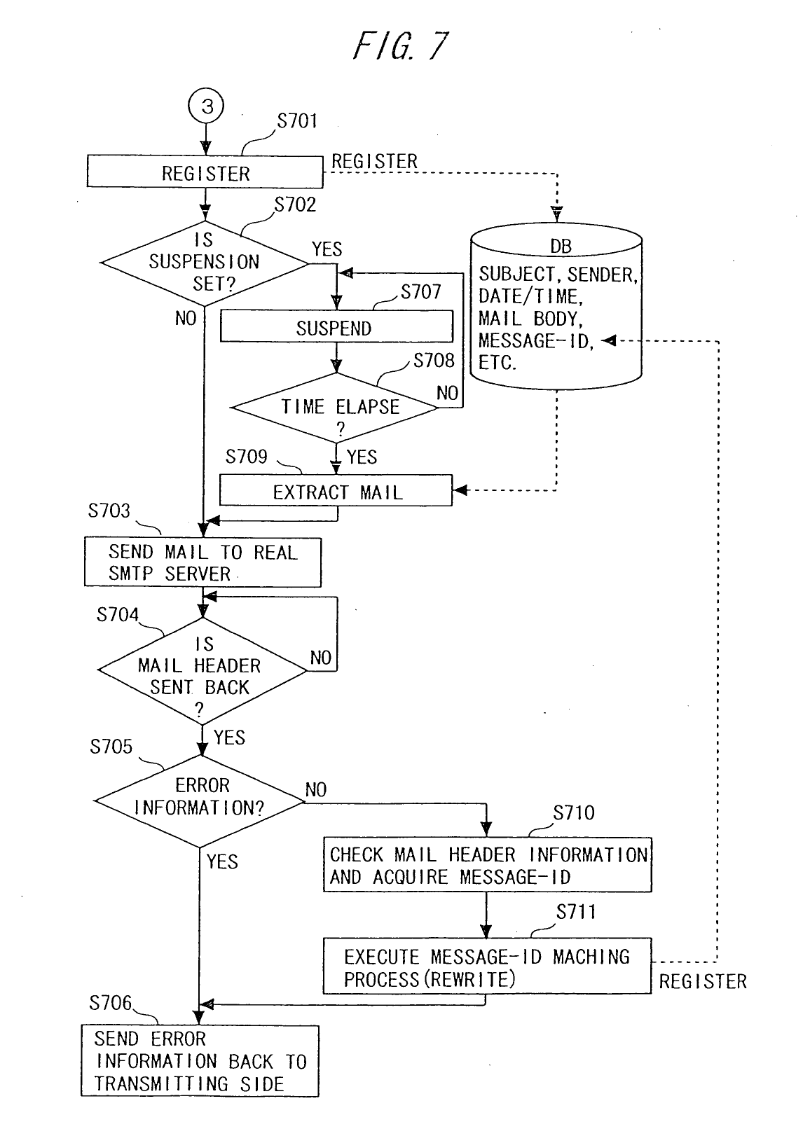

In a case where this processing code is not added (S404, No), the virtual SMTP server construes the received mail as a normal mail, and advances to S701 shown in FIG. 7, wherein the virtual SMTP server executes the normal mail processes.

In the normal mail processes in FIG. 7, the virtual SMTP server registers a suspension of the mail transmission, the mail and its appendix information in a database, and executes a Message-ID matching process after transmitting the mail to the real SMTP server (S701-S711 in FIG. 7). The processes shown in FIG. 7 will be explained later on.

By contrast, in the case of judging in S404 that the delete or update code is attached to the mail (S404, Yes), the virtual SMTP server construes the received mail as a mail for deleting or updating, then acquires Message-ID designated by this mail, and makes a comparison with the data in the DB by referring to the DB of the virtual SMTP server (S405).

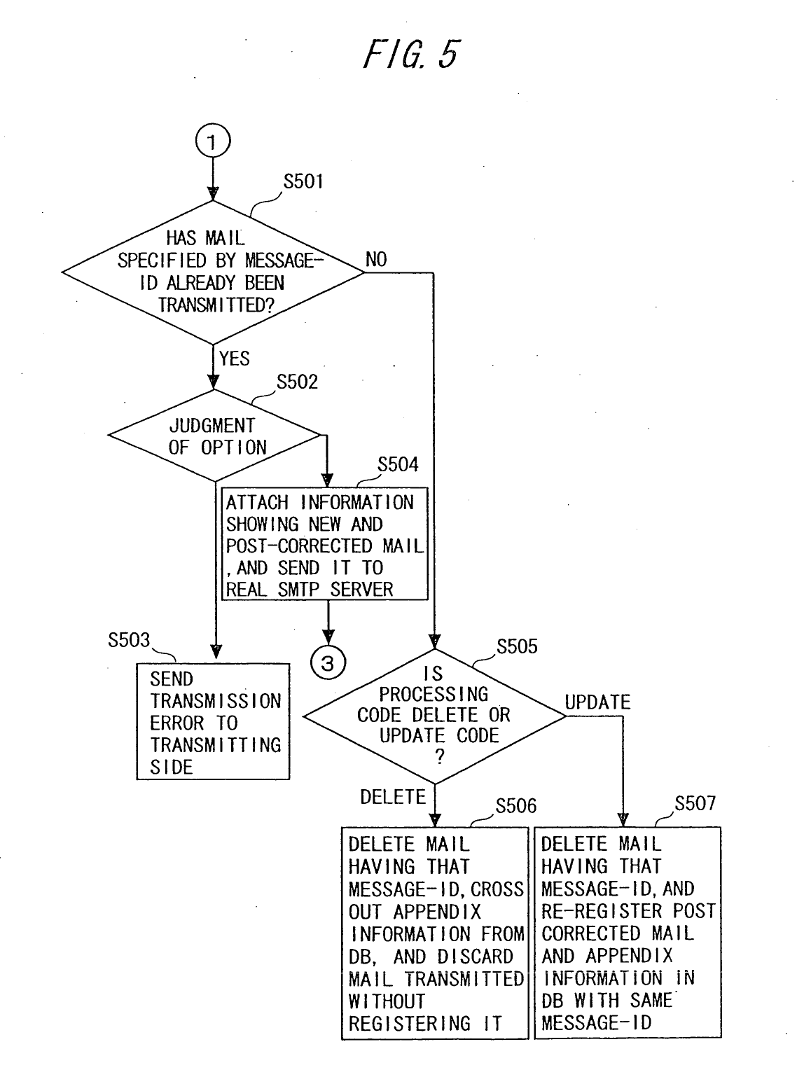

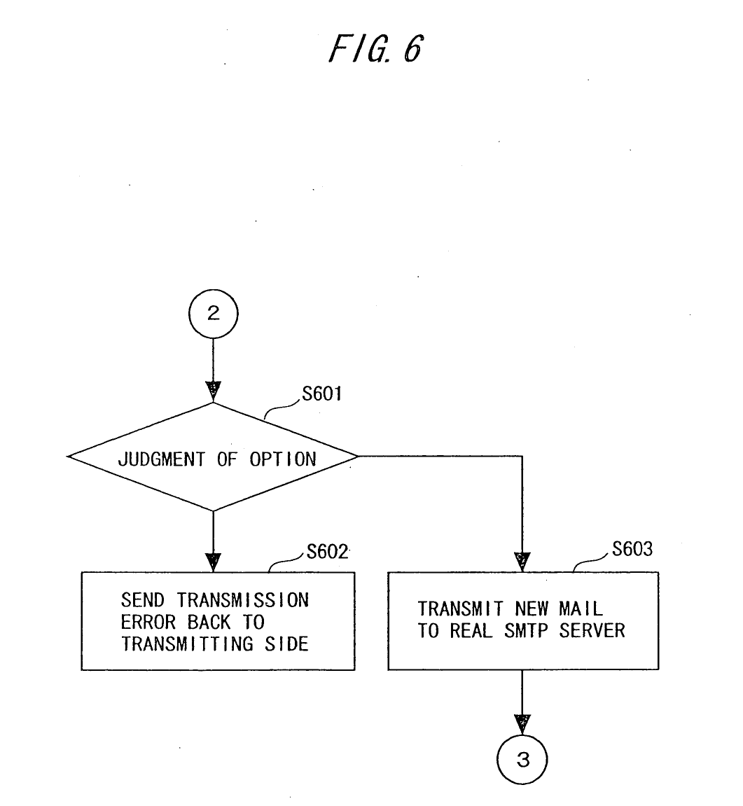

Then, the virtual SMTP server, if the DB contains a mail having the designated Message-ID (Yes), moves to S501 shown in FIG. 5, and advances to S601 shown in FIG. 6 whereas if the DB does not contain (No).

In S501 shown in FIG. 5, the virtual SMTP server checks whether or not the mail specified by Message-ID has already been transmitted to the real SMTP server.

Then, if already transmitted (Yes), the virtual SMTP server selects through option setting whether an error is sent back to the client on the transmitting side (S503) or the mail is forwarded as a new mail (S504).

In the case of transmitting the mail as the new mail (S504), the code and Message-ID, which have been attached so far to the mail, are deleted, and instead a piece of information purporting that the mail is a post-correction mail is attached, and this new mail is sent to the real SMTP server. This piece of information is, for instance, “corrected”, etc. and helps a recipient recognize it as a post-correction mail. Note that the mail transmission process in S504 is executed in the same way as the new mail transmission process shown in FIG. 7 is executed, except for deleting Message-ID and attaching the information purporting that the mail is the post-correction mail. In the case of the mail transmission process in S504, however, the mail may be sent directly to the real SMTP server without via a suspension process (S702, S707, S708, S709).

If it is judge in S501 that the mail specified by Message-ID is not yet transmitted (No), the virtual SMTP server judges whether the processing code attached to the mail is the delete code or the update code (S505). If the code is the delete code, the mail registered in the DB is deleted (S506), and, if the code is the update code, the contents of the mail stored on the DB are updated (S507).

Namely, the virtual SMTP server, in the case where the processing code attached to the mail is the delete code, deletes the mail having this Message-ID and deletes the appendix information thereof from the DB. Further, the virtual SMTP server discards the transmitted mail with registering this mail (S506).

Moreover, the virtual SMTP server, in the case where the processing code attached to the mail is the update code, deletes the mail having Message-ID stored on the DB, and re-registers the post-correction mail and its appendix information on the DB by use of the same Message-ID (S507).

In the case of this post-correction mail, the mail is registered in a way that deletes the update processing code and Message-ID from the mail attached with the update processing code.

While on the other hand, if it is judged in S406 in FIG. 4 that there is no relevant Message-ID (No), the virtual SMTP server makes a judgment about options in S601 shown in FIG. 6.

Then, the virtual SMTP server, in a case where the set option is an option of obtaining consent and a judgment of the sender by sending a piece of transmission error information back to the sender side without performing anything particular, sends the transmission error back to the transmitting side (S602).

Further, the virtual SMTP server, in a case where the set option is an option of dealing with the mail in the same way as with a new mail (attached with neither the processing codes nor Message-ID) and sending this mail as a new mail to the real SMTP server, sends the mail as the new mail to the real SMTP server (S603).

Namely, the virtual SMTP server, in S603, deletes the processing code and Message-ID from the mail attached with the processing code, thus creating the new mail.

Note that the mail transmission process in S603 is executed with a shift to the new mail process shown in FIG. 7, except for the process of deleting the processing code and Message-ID. In the case of the mail transmission process in S603, however, the mail may be transmitted directly to the real SMTP server without via the suspension process (S702, S707, S708, S709).

Next, an operation when the mail received by the virtual SMTP server is sent to the real SMTP server in the mail system in the embodiment, will be explained referring to FIG. 7. FIG. 7 is a flowchart of an operation when sending the mail received by the virtual SMTP server to the real SMTP server in the mail system shown in FIG. 1.

In S701, the virtual SMTP server registers information about the received mail in the DB. The DB is stored with a subject, a sender, a date/time, a mail body, Message-ID of the mail.

Next, the virtual SMTP server judges whether a suspension setting is made or not (S702). The suspension is effected in the virtual SMTP server so that the received mail is sent to the real SMTP server after a fixed period of time.

The virtual SMTP server, if the suspension setting is made (Yes), temporarily suspends the mail transmission to the real SMTP server (S707) and judges whether or not the fixed period of time has elapsed (S708). If the fixed period of time has elapsed (Yes), the virtual SMTP server moves to S709.

For instance, the virtual SMTP server monitors the elapsed time for every received mail identified by Message-ID. In a case where the received mail is replaced by a mail having the same Message-ID after being updated by the update process, the elapsed time of the updated mail, which has been used so far, may or may not be used as an elapsed time of the post-updating mail.

In S709, the virtual SMTP server extracts from the DB the information about the mail to be transmitted, and thereafter sends the mail to the real SMTP server (S703).

After transmitting the mail to the real SMTP server, the virtual SMTP server judges whether the mail header is sent back or not. If sent back (Yes), the virtual SMTP server moves to S705, wherein the virtual SMTP server judges whether there is the error information or not.

In the case of judging in S705 that there is the error information (Yes), the virtual SMTP server sends the error information back to the client on the transmitting side.

While on the other hand, in the case of judging in S705 that there is no error information (No), the virtual SMTP server checks the mail header information, then acquires Message-ID, and executes the matching process (rewrite) of Message-ID in the DB.

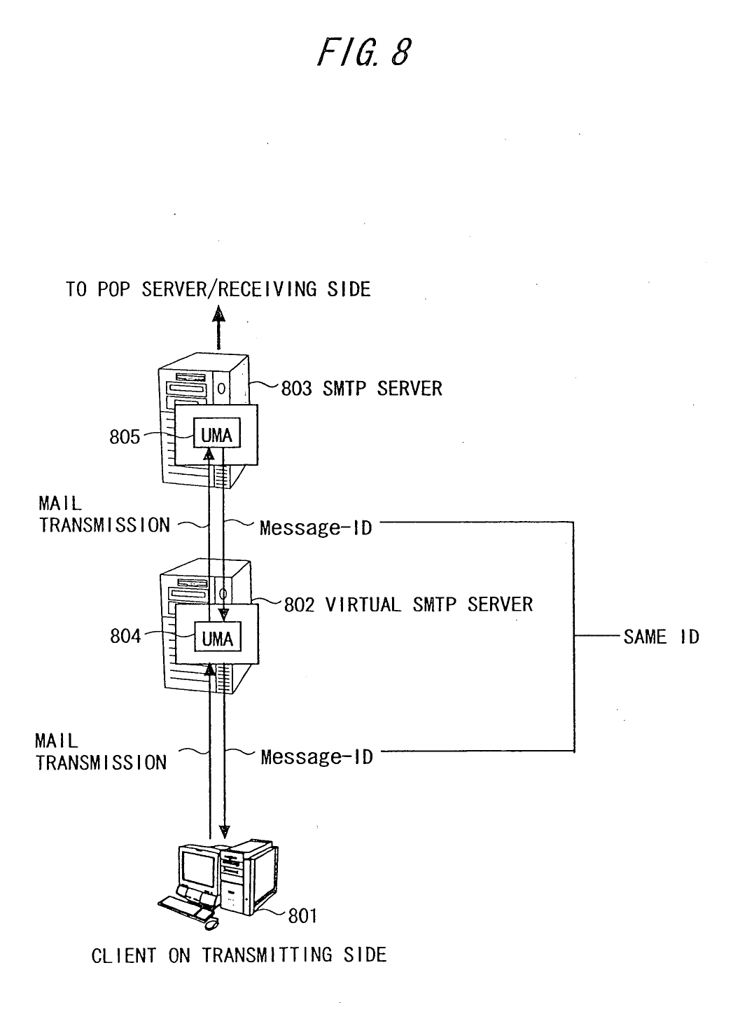

Herein, the Message-ID matching process in S711 shown in FIG. 7 will be explained with reference to FIG. 8. FIG. 8 is a conceptual diagram of an operation of the Message-ID matching process in S711 shown in FIG. 7.

As shown in FIG. 8, a virtual SMTP server 802 has a function of the SMTP software, and the SMTP software for surrogating the transmission/receipt of the mail is installed into a real SMTP server 803.

Then, UMA (User message Agent) is installed into each of the virtual SMTP server 802 and the SMTP server 803 as a function of SMTP software. The UMA generates Message-ID.

As illustrated in FIG. 8, when the client on the transmitting side sends the mail to the virtual SMTP server 802, UMA 804 of the virtual SMTP server 802 sends (forwards) the mail to the real SMTP server 803 after a fixed period of time due to the suspension setting.

The real SMTP server 803 having received the mail generates Message-ID by use of the UMA 805, and sends the mail header back to the virtual SMTP server 802.

Then, the UMA 804 of the virtual SMTP server 802 checks Message-ID on the basis of the mail header sent back from the real SMTP server 803.

Subsequently, the UMA 804, if Message-ID exists, incorporates this Message-ID as it is into the mail header by way of Message-ID generated by the virtual SMTP server 802, and sends the mail header back to the client 801 on the transmitting side. The method of sending back the mail header is the same as by the normal mail system.

<Concerning Message-ID>

Next, Message-ID used in the embodiment will be described.

Message-ID is a piece of information for describing an identifier of a message of a mail or news, and Message-ID of each message is globally unique.

Generation of Message-ID is one of functions possessed by the UMA, and therefore the server (host) installed with this piece of software generates Message-ID.

Generally, it does not happen in a normal case that the client generates Message-ID, and the server (host) side must assure that Message-ID is unique.

In the embodiment, the real SMTP server generates Message-ID in the mail header, and the virtual SMTP server having received Message-ID is to send this Message-ID back to the client.

If the mail is not yet sent back to the real SMTP server due to the mail suspension in the virtual SMTP server, however, the virtual SMTP server temporarily generates Message-ID and notifies the client of this Message-ID.

When transmitting the mail after the fixed period of time, it follows that Message-ID generated by the real SMTP server replaces Message-ID generated by the virtual SMTP server.

In this case, the virtual SMTP server is stored with Message-ID before being sent to the real SMTP server and is therefore capable of specifying the mail without any problem.

Message-ID is unique in nature, and it is therefore possible to prevent an overlap of the mail and to generate a thread in combination with “In-Reply-To” and “Reference”.

Herein, “In-Reply-To” is a process standard for designating a transmitting destination or a reply destination of the mail. This is the process standard, wherein in the case of sending the mail attached with “In-Reply-To” to the destination party, when the destination party sends or replies “To” the (received) mail having Message-ID thereof, the transmitting destination automatically becomes the destination party designated by “In-Reply-To”.

“Reference” has a meaning of “reference”, wherein when a specified Message-ID is specified to “Reference”, a mail to be referred to can be specified.

These process standards “In-Reply-To” and “Reference” are the process standards different from Message-ID.

Further, the generation of the thread implies creating a mail.

Moreover, the message as a reference source can be also specified by attaching Message-ID referred to in the body to the mail.

Therefore, Message-ID is indispensable for a mailing list and news.

A requirement of RFC822 is that the Message-ID format be unique in <local-part“@”domain>.

A method of actualizing this format is that a domain name or a domain literal (a description method of an IP address such as “202.224.39.39”) in which a message is created, is described on the right side of “@”, and a character string (for example, a combination of a date/time of generation, a process ID, a generation number, etc.) assured to be unique in the domain, is described on the left side thereof.

Namely, FQDN (Fully Qualified Domain Name) is globally unique, and hence, if the character string is unique in the host thereof, Message-ID as a combination becomes unique.

Herein, FQDN (Fully Qualified Domain Name) is a format for designating all the character elements up to the domain name subsequent to the host name without any omission on the Internet. For example, this is the format that designates all the character elements of the host name (host) and the domain name (example.co.jp) as in “host.example.co.jp”.

Note that the standards for Message-ID are defined in the RFC standards documents.

<Mechanism for Updating Wrong Mail into Corrected Mail>

Next, a mechanism for updating a wrong mail into a corrected mail will be explained with reference to the drawings by way of one example of the operation of the electronic mail storage method according to the invention.

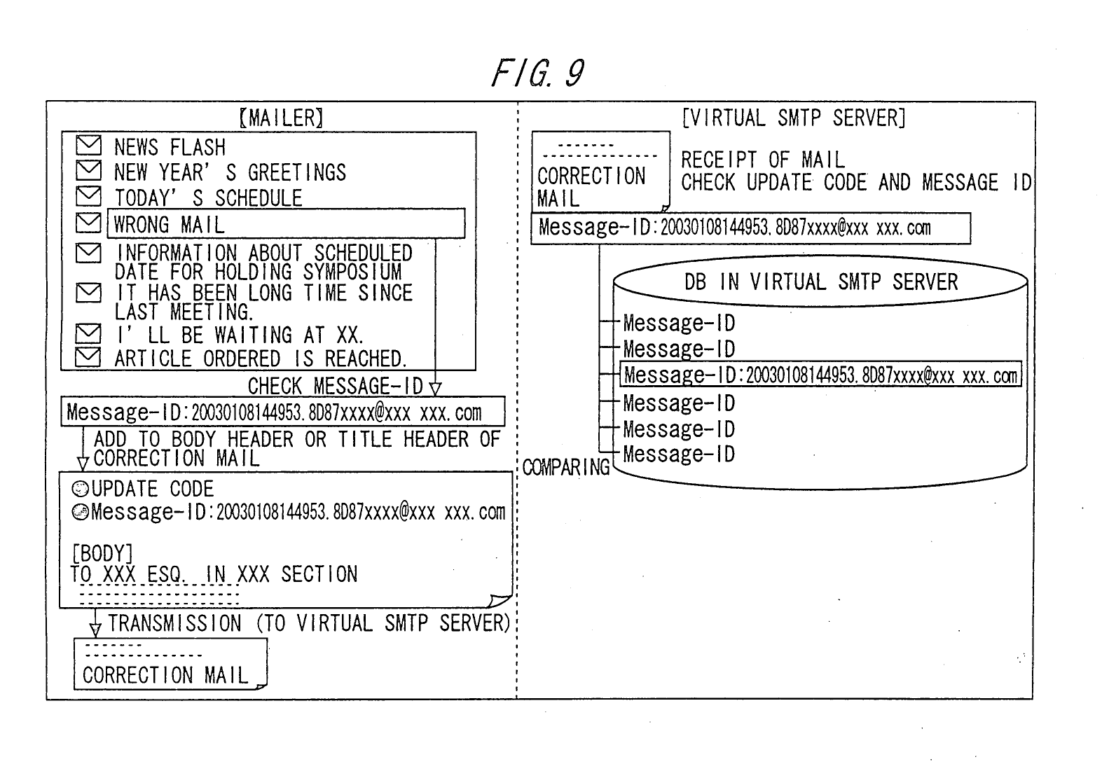

As shown in FIG. 9, in the case of updating the wrong mail into the corrected mail, the client mailer is require to previously examine Message-ID of the mail to be corrected among the mails (e.g., in the out-box) transmitted by the user. FIG. 9 is a conceptual diagram of the mechanism for updating the wrong mail into the corrected mail in one embodiment of the electronic mail storage method according to the invention.

This Message-ID has a value unique to every mail. The client mailer describes this Message-ID in the body (for the subject field) of the post-correction mail together with the update code, and transfers the mail to the virtual SMTP server.

The update code is a peculiar code for requesting the virtual SMTP server to update the mail having the designated Message-ID. The virtual SMTP server judges from this code attached or unattached whether the mail transferred to the virtual SMTP server is a new mail or a corrected mail.

The virtual SMTP server having received the mail decodes the mail body and, if the update code is written, searches the database for Message-ID thereof.

Then, in a case where Message-ID coincident with received Message-ID is detected, the virtual SMTP server executes, for instance, the following two processes.

First Process:

A case where the mail having the coincident Message-ID has already been transmitted (transferred to the POP server):
1) The virtual SMTP server executes a process of deleting the update code and Message-ID from the post-correction mail and sending the mail to the destination party in a way that instead adds a piece of information purporting that the mail is the post-correction mail.
2) Content and a judgment of the sender is obtained by sending the transmission error information to the client on the sender side without performing anything particular.

The virtual SMTP server is capable of designating which process, 1) or 2), is executed.

Second Process:

A case where the mail having the coincident Message-ID is not yet transmitted:

A pre-correction mail having Message-ID of the received mail is deleted from the DB, and the pre-correction mail is replaced with the post-correction mail by further deleting the update code and Message-ID from the post-correction mail.

On the other hand, in case where the coincident Message-ID is not detected, the following operations are carried out.

1) The mail is treated equally to a new mail (to which none of the update code and Message-ID are added).

2) Content and a judgment of the sender is obtained by sending the transmission error information to the client on the sender side without performing anything particular.

The virtual SMTP server is capable of designating which process, 1) or 2), is executed.

In the case of being applied to none of those mentioned above, that is, if the mail forwarded to the virtual SMTP server is ordinarily created as a new mail, the virtual SMTP server executes the process as the normal SMTP server does.

As a matter of course, if within a limit time, the virtual SMTP server is also capable of only deleting (canceling) the transmission mail.

Further, a timing at which the virtual SMTP server sends the mail forwarded to the real SMTP server, i.e., forwards the mail to the POP server, is posterior to an elapse of the limit time (a mail holding time) set by the virtual SMTP server.

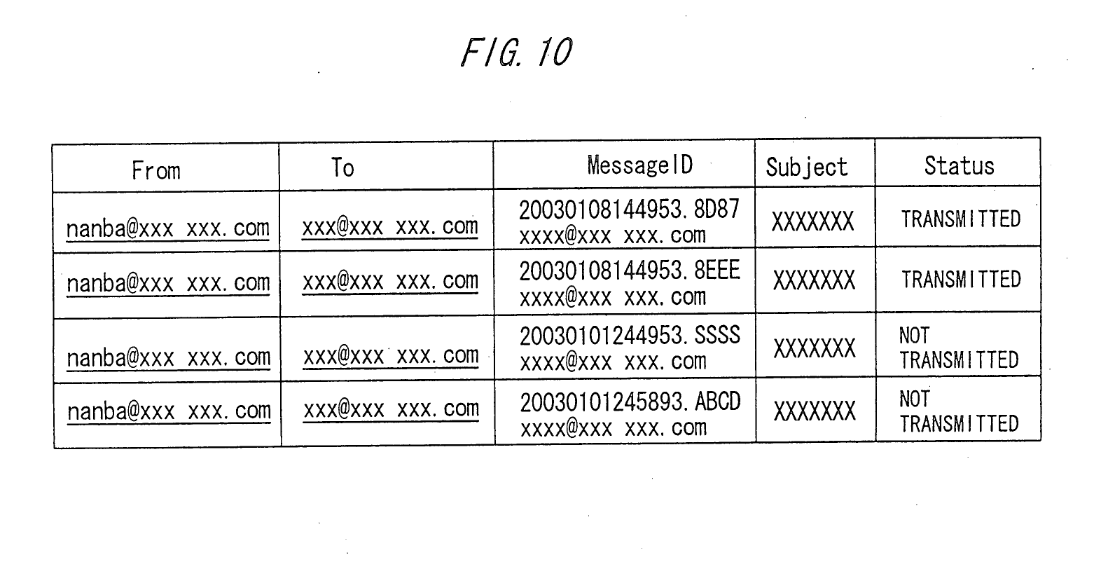

Incidentally, the data stored in the DB to which the virtual SMTP server refers on the occasion of the above processes, will be explained with reference to FIG. 10. FIG. 10 is a conceptual diagram of the data in the DB to which the virtual SMTP server refers on the occasion of updating the wrong mail into the corrected mail in one embodiment of the electronic mail storage method according to the invention.

As shown in FIG. 10, the DB is stored with a sender (Form), a recipient (To), Message-ID, Subject and Status.

Status stores information which designates whether the mail is already transmitted to real SMTP server or not.

Note that the update of the mail body and the deletion of the mail itself have been exemplified in the embodiment, however, the invention is not limited to such a case.

For instance, a destination and a subject of the already-sent mail other than the mail body can be also changed.

For example, in the case of changing the destination, the client attaches, e.g., Message-ID to the subject or the body, also attaches a process code indicating the change in destination to the subject or the body, and further sends, to the virtual SMTP server, the mail having the destination changed to the destination after being corrected.

The virtual SMTP server, as in the case of updating the mail body described above, deletes the mail of which the already-registered destination specified by Message-ID should be corrected, replaces this mail with a mail transmitted as it is addressed to the post-correction destination, and registers this mail. On the occasion of this replacement, Message-ID and the process code are deleted from the post-correction mail.

The destination of the mail that has been already transmitted to the virtual SMTP server can be thereby changed simply by the mail transmission.

Accordingly, in the mail system in the embodiment, owing to the change in destination, even if the mail is sent to, for example, a wrong destination set in the mailing list, the destination is changed by restarting so as to make a change to the destination of the correct mail, and it is feasible to transmit the mail to each destination on the correct mailing list.

Further, in the mail system according to the embodiment, even in a case where the already-sent mail has an attachment file, this file can be changed afterward to a desired file.

Namely, the client on the transmitting side, in the case of changing the file attached to the already-sent mail, attaches the file after being changed, also attaches Message-ID to the subject or the body, and further attaches the process code indicating a change of the file to the subject or the body.

Then, the client on the transmitting side transmits the mail attached with the process code to the virtual SMTP server.

The virtual SMTP server, as in the case of updating the mail body described above, deletes the specified-by-Message-ID and already-registered mail attached with the pre-change file, replaces this mail with a mail attached with a want-to-change file, and registers the thus replaced mail. On the occasion of this registration, for instance, the virtual SMTP server deletes Message-ID and the process code from the mail attached with the post-change file.

Through this process, the file attached to the mail already transmitted to the virtual SMTP server can be changed to the desired file simply by the mail transmission.

Further, in the mail system to which the embodiment is applied, if the mailer utilized at the present by the client supports a plug-in (the addition of function), it is possible to create the plug-in for automating the additions of Message-ID and the process code, and cancellation and updating of the transmission mail.

Thus, the mail system to which the embodiment is applied, can be applied to a case of distributing the mailing list as well as to the normal mail transmitting/receiving system.

Owing to the invention, usability is improved, the processes such as deleting and updating the transmitted mail can be executed by sending the mail without changing the existing or well-accustomed mailer.

Further, according to the invention, the process such as deleting or updating is executed before the receiving-side device receives the mail, and hence an elaborate consideration can be given to the receiving side, and there is no increase of futile logs.

1. A mail system which comprises a client for transmitting a mail and a server for receiving the mail, said mail system comprising:
a receiving unit receiving a first mail transmitted from said client and receiving a second mail transmitted from said client after the first mail;
a storage unit storing the first mail received;
a judging unit judging whether a process code for processing the first mail and specifying information for specifying the first mail are attached to the second mail or not;
a processing unit executing, in a case where the process code and the specifying information are attached to the second mail, a process for the first mail stored on said storage unit and specified by the specifying information in accordance with the process code; and
a transmitting unit transmitting, after a fixed period of time has elapsed since the receipt of the first mail, to said server the first mail stored on said storage unit or the second mail of which the process code and the specifying information have been deleted.

2. A mail system according to claim 1, wherein the process code is attached to a body of the second mail.

3. A mail system according to claim 1, wherein the process code is attached to a subject of the second mail.

4. A mail system according to claim 1, wherein the specifying information is attached to a body of the second mail.

5. A mail system according to claim 1, wherein the specifying information is attached to a subject of the second mail.

6. A mail system according to claim 1, wherein the process code attached to the second mail is an update code indicating a process of updating a body of the first mail,
contents of an updated body of the first mail is attached to a body of the second mail, and
said processing unit deletes the specifying information and the update code attached to the second mail, deletes the first mail specified by the specifying information and stores in said storage unit the second mail of which the specifying information and the update code have been deleted.

7. A mail system according to claim 1, wherein the process code attached to the second mail is an update code indicating a process of deleting the first mail, and
said processing unit deletes the first mail specified by the specifying information from said storage unit.

8. A mail system according to claim 1, wherein the process code attached to the second mail is an update code indicating a process of updating a destination of the first mail,
the second mail is sent to an updated destination, and
said processing unit deletes the specifying information and the update code attached to the second mail, deletes the first mail specified by the specifying information and stores in said storage unit the second mail of which the specifying information and the update code have been deleted.

9. A mail system according to claim 1, wherein the process code attached to the second mail is a change code indicating a process of changing a file attached to the first mail,
a changed file attached to the first mail is attached to the second mail, and
said processing unit deletes the specifying information and the change code attached to the second mail, deletes the first mail specified by the specifying information and stores in said storage unit the second mail to which the changed file has been attached and of which the specifying information and the change code have been deleted.

10. A mail processing method for a virtual server in a mail system which comprises a client for transmitting a mail and a server for receiving the mail transmitted from said virtual server, said mail processing method comprising:
receiving a first mail transmitted from said client;
receiving a second mail transmitted from said client after the first mail;
storing in a storage unit the first mail received;
judging whether a process code for processing the first mail and specifying information for specifying the first mail are attached to the second mail or not;
executing, in a case where the process code and the specifying information are attached to the second mail, a process for the first mail stored on said storage unit and specified by the specifying information in accordance with the process code; and
transmitting, after a fixed period of time has elapsed since the receipt of the first mail, to said server the first mail stored on said storage unit or the second mail of which the process code and the specifying information have been deleted.

11. A mail processing method according to claim 10, wherein the process code is attached to a body of the second mail.

12. A mail processing method according to claim 10, wherein the process code is attached to a subject of the second mail.

13. A mail processing method according to claim 10, wherein the specifying information is attached to a body of the second mail.

14. A mail processing method according to claim 10, wherein the specifying information is attached to a subject of the second mail.

15. A mail processing method according to claim 10, wherein the process code attached to the second mail is an update code indicating a process of updating a body of the first mail,
contents of an updated body of the first mail is attached to a body of the second mail, and said mail processing method further comprises:
deleting the specifying information and the update code attached to the second mail;
deleting the first mail specified by the specifying information; and
storing in said storage unit the second mail of which the specifying information and the update code have been deleted.

16. A mail processing method according to claim 10, wherein the process code attached to the second mail is an update code indicating a process of deleting the first mail, and said mail processing method further comprises:
deleting the first mail specified by the specifying information from said storage unit.

17. A mail processing method according to claim 10, wherein the process code attached to the second mail is an update code indicating a process of updating a destination of the first mail, the second mail is sent to an updated destination, and said mail processing method further comprises:
deleting the specifying information and the update code attached to the second mail;
deleting the first mail specified by the specifying information; and
storing in said storage unit the second mail of which the specifying information and the update code have been deleted.

18. A mail processing method according to claim 10, wherein the process code attached to the second mail is a change code indicating a process of changing a file attached to the first mail and a changed file attached to the first mail is attached to the second mail, and said mail processing method further comprises:
deleting the specifying information and the change code attached to the second mail;
deleting the first mail specified by the specifying information; and
storing in said storage unit the second mail to which the changed file has been attached and of which the specifying information and the change code have been deleted.

19. A computer-readable recording medium that records a mail processing program executed by a computer that functions as a virtual server in a mail system which comprises a client for transmitting a mail and a server for receiving the mail transmitted from said virtual server, said mail processing program comprising:
receiving a first mail transmitted from said client;
receiving a second mail transmitted from said client after the first mail;
storing in a storage unit the first mail received;
judging whether a process code for processing the first mail and specifying information for specifying the first mail are attached to the second mail or not;
executing, in a case where the process code and the specifying information are attached to the second mail, a process for the first mail stored on said storage unit and specified by the specifying information in accordance with the process code; and
transmitting, after a fixed period of time has elapsed since the receipt of the first mail, to said server the first mail stored on said storage unit or the second mail of which the process code and the specifying information have been deleted.

20. A computer-readable recording medium that records a mail processing program according to claim 19, wherein the process code is attached to a body of the second mail.

21. A computer-readable recording medium that records a mail processing program according to claim 19, wherein the process code is attached to a subject of the second mail.

22. A computer-readable recording medium that records a mail processing program according to claim 19, wherein the specifying information is attached to a body of the second mail.

23. A computer-readable recording medium that records a mail processing program according to claim 19, wherein the specifying information is attached to a subject of the second mail.

24. A computer-readable recording medium that records a mail processing program according to claim 19, wherein the process code attached to the second mail is an update code indicating a process of updating a body of the first mail,
contents of the updated body of the first mail is attached to the body of the second mail, and
said executing step comprises:
deleting the specifying information and the update code attached to the second mail,
deleting the first mail specified by the specifying information, and
storing in said storage unit the second mail of which the specifying information and the update code have been deleted.

25. A computer-readable recording medium that records a mail processing program according to claim 19, wherein the process code attached to the second mail is an update code indicating a process of deleting the first mail, and
said executing step comprises deleting the first mail specified by the specifying information from said storage unit.

26. A computer-readable recording medium that records a mail processing program according to claim 19, wherein the process code attached to the second mail is an update code indicating a process of updating a destination of the first mail,
the second mail is sent to an updated destination, and
said executing step comprises deleting the specifying information and the update code attached to the second mail, deleting the first mail specified by the specifying information and storing in said storage unit the second mail of which the specifying information and the update code have been deleted.

27. A computer-readable recording medium that records a mail processing program according to claim 19, wherein the process code attached to the second mail is a change code indicating a process of changing a file attached to the first mail,
a changed file attached to the first mail is attached to the second mail, and
said executing step comprises deleting the specifying information and the update code attached to the second mail, deleting the first mail specified by the specifying information and storing in said storage unit the second mail to which the changed file has been attached and of which the specifying information and the update code have been deleted.

28. An electronic mail storage device, comprising:
a storage unit storing the electronic mail;
a receiving unit receiving an electronic mail to be temporarily stored in said storage unit;
a search unit searching the electronic mail received by said receiving unit for a piece of specifying information for specifying other electronic mail stored on said storage unit and a piece of process information for processing an electronic mail specified by the specifying information; and
a processing unit executing, in a case the electronic mail includes the piece of process information and the piece of specifying information, a process for the specified electronic mail in accordance with the piece of process information.

29. An electronic mail storage device according to claim 28, wherein the piece of process information is a piece of update information indicating a process of updating a body of the specified electronic mail,
contents of an updated body of the specified electronic mail is attached to a body of the electronic mail, and
said processing unit deletes the piece of specifying information and the piece of update information from the electronic mail, deletes the specified electronic mail from said storage unit, and stores the electronic mail on said storage unit.

30. An electronic mail storage device according to claim 28, wherein the piece of process information is a piece of update information indicating a process of deleting the specified electronic mail, and
said processing unit deletes the specified electronic mail from said storage unit.

31. An electronic mail storage method of temporarily storing in a storage device an electronic mail to be transmitted, comprising:
receiving an electronic mail to be temporarily stored in a storage device;
searching the received electronic mail for a piece of specifying information for specifying other electronic mail stored on said storage device and a piece of process information for processing an electronic mail specified by the piece of specifying information; and
executing, in a case the received electronic mail includes the piece of process information and the specifying information, a process for the specified electronic mail in accordance with the piece of process information.

32. A computer-readable recording medium that records an electronic mail storage program for temporarily storing in a storage device an electronic mail to be transmitted, said program making a computer execute:
receiving operation receiving an electronic mail to be temporarily stored in a storage device;
searching operation searching the received electronic mail for a piece of specifying information for specifying other electronic mail stored on said storage device and a piece of process information for processing an electronic mail specified by the specifying information; and
processing operation processing, in a case the received electronic mail includes the piece of process information and the piece of specifying information, for the piece of specified electronic mail in accordance with the piece of process information.
